(19) United States
(12) Patent Application Publication
(10) Pub. No.: US 2015/0076128 A1
(43) Pub. Date: Mar. 19, 2015

(54) WELD MONITORING APPARATUS

(71) Applicant: Caterpillar Inc., Peoria, IL (US)

(72) Inventors: Thierry A. Marchione, Heber City, UT (US); Leon R. Adcock, Chillicothe, IL (US); Huijun Wang, Peoria, IL (US)

(73) Assignee: Caterpillar Inc., Peoria, IL (US)

(21) Appl. No.: 14/552,520

(22) Filed: Nov. 25, 2014

(51) Int. Cl. B23K 9/095; B23K 9/12

(52) U.S. Cl. CPC B23K 9/0956; B23K 9/126
USPC 219/130.21

(57) ABSTRACT

A welding apparatus for applying consecutive welding beads during a welding operation includes a welding unit including a torch head and a power circuit. The welding apparatus further includes a first pyrometer and a second pyrometer positioned respectively at a first and second pre-determined distance from a tip portion of the torch head, the first and second pyrometers are configured to respectively generate a first temperature signal and a second temperature signal indicative of temperatures of a portion of successive welds. The welding apparatus further includes a controller configured to receive the first temperature signal and the second temperature signal, determine a difference between the first and second temperature signals, set a predetermined threshold based, at least in part, on the determined difference, and adjust a welding parameter of the power circuit, wherein the adjusted welding parameter is lesser than the predetermined threshold.

### TECHNICAL FIELD

The present disclosure relates to a welding apparatus, and more particularly towards a system and method for real time thermal monitoring of a weld portion during a welding operation.

### BACKGROUND

Thermal joining processes in modern manufacturing technology, for example, autogenous fusion welding, Gas Tungsten Arc Welding (GTAW), Plasma Arc (PAW), Laser Beam (LBW) and Electron Beam Welding (EBW) are prevalent in the production industry. These modern methods, combined with automated mechanized and robotic torch motion systems, enable closer control of the weld bead geometry, the material structure and properties, and the thermal stress or distortion effects of the weld, thus contributing to an enhanced joint quality and productivity of welding operations.

In the mentioned processes, torch power and torch motion primarily govern the desired characteristics of the final weld. To handle the welding transients such as, the material and torch parameter uncertainty, and process disturbances, sophisticated in-process control systems have been proposed which employ measurement and feedback of some weld variables in order to modulate the torch intensity and speed in real-time. However, such implementations may be expensive, difficult to install, and have limited flexibility in the welding process.

Further, during direct metal additive manufacturing, welding material is used to build up an object in a process such as cold metal transfer (CMT) additive manufacturing. However, overheating of the weld material during the welding process may lead to buildup collapse, which in turn may alter the final geometry of the part. Some welding systems make pauses between successive passes of the welding process to control the build up.

U.S. Pat. No. 5,506,386 describes simultaneous temperature measurements on laser welded seams with at least two pyrometers in relation to monitoring process parameters and weld quality. In laser butt welding of metal sheets, in particular sheets of unequal thicknesses, the temperature is measured at two points behind the liquid-solid interface. From combination of the two readings obtained a series of process data can be derived whereby the welding process can be monitored.

### SUMMARY OF THE DISCLOSURE

In one aspect of the present disclosure, a welding apparatus for applying consecutive welding beads during a welding operation is described. The welding apparatus includes a welding unit including a torch head and a power circuit. The welding apparatus further includes a first pyrometer and a second pyrometer positioned respectively at a first and second pre-determined distance from a tip portion of the torch head, the first and second pyrometers are configured to respectively generate a first temperature signal and a second temperature signal indicative of temperatures of a portion of successive welds. The welding apparatus further includes a controller configured to receive the first temperature signal and the second temperature signal, determine a difference between the first and second temperature signals, set a predetermined threshold based, at least in part, on the determined difference, and adjust a welding parameter of the power circuit, wherein the adjusted welding parameter is lesser than the predetermined threshold.

Other features and aspects of this disclosure will be apparent from the following description and the accompanying drawings.

### BRIEF DESCRIPTION OF THE DRAWINGS

FIG. 1 is a schematic view of a welding apparatus, according to one embodiment of the present disclosure;

FIG. 2 is a schematic view of a welding operation conducted by the welding apparatus of FIG. 1, according to one embodiment of the present disclosure; and

FIG. 3 is a schematic view of another welding operation conducted by the welding apparatus of FIG. 1, according to one embodiment of the present disclosure.

### DETAILED DESCRIPTION

Reference will now be made in detail to specific embodiments or features, examples of which are illustrated in the accompanying drawings. Wherever possible, corresponding or similar reference numbers will be used throughout the drawings to refer to the same or corresponding parts.

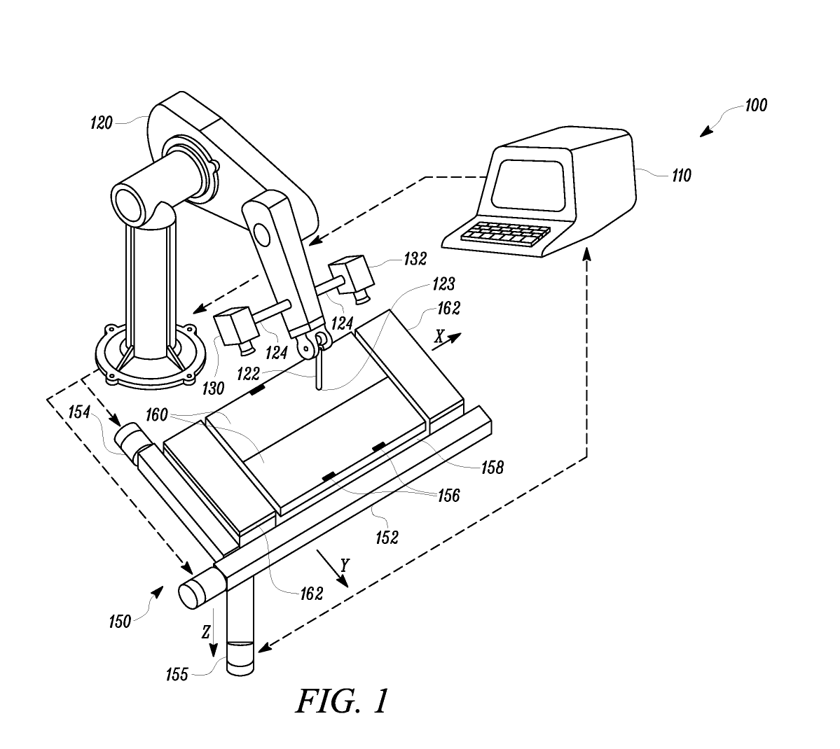

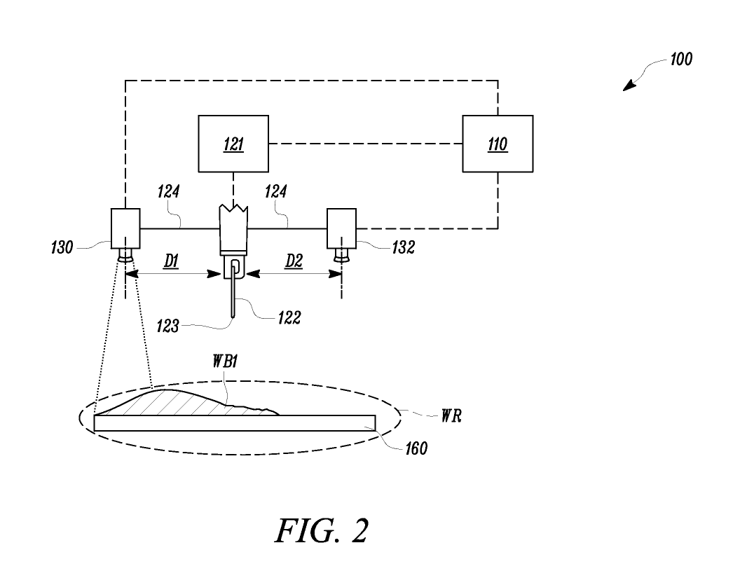

Turning now to the figures, a welding apparatus 100 constructed according to the principles of the present disclosure is schematically illustrated in FIG. 1. Specifically, a controller 110, such as a computer, controls a welding unit 120 and an X-Y-Z table 150. The controller 110 may be a proportional-integral (PI) controller or an operational amplifier (OP-AMP) controller. The welding unit 120 includes a torch head 122 for welding a weld part or work piece consisting of a plurality of metal components 160. The welding unit 120 also includes a power circuit 121 (see FIG. 2) in communication with the controller 110. The power circuit 121 has conventional circuitry associated therewith, comprising of amperage and voltage components. The power circuit 121 is configured to be controlled by the controller 110 to control and adjust one or more welding parameters associated with the welding unit 120. The welding unit 120 includes an automated robotic assembly. During a welding operation, the torch head 122 is scanned across the metal components 160 by the coordinated movement of the welding unit 120 and the X-Y-Z table 150, as dictated by the controller 110. The controller 110 simultaneously modulates power to the torch head 122 via the power circuit 121.

The torch head 122 is any non-consumable type electrode, for example, a gas tungsten arc welding (GTAW) head, a plasma arc welding (PAW) head, or a gas metal arc welding (GMAW) head. Alternatively, the welding unit 120 and the torch head 122 may be replaced with a laser beam (LBW) or electron beam welder (EBW). In these welding devices, scanning may be accomplished by deflecting the laser or electron beams, which may serve as the torch head 122, rather than physically scanning an electrode over the surface of the metal components 160.

The X-Y-Z table 150 is capable of translating the metal components 160 along the X, Y, and Z axes to facilitate the scanning the torch head 122 across the metal components 160. The X-Y-Z table 150 comprises an X actuator stage 152, a Y actuator stage 154, and a Z actuator stage 155 controlled by the controller 110. The metal components 160 are restricted from lateral movement by one or more fixtures 156 that clamp the metal components 160 onto the table base 158. The metal components 160 are secured from longitudinal movement by an end dummy component 162 placed at either end of the metal components 160. Alternatively, the torch head 122 may be stationary and the scanning may be accomplished by the movement of the metal components 160 by the table 150. In one embodiment, the metal components 160 may be stationary and the torch head 122 may be moved relative to the metal components 160 by the welding unit 120. As mentioned earlier, movement of the torch head 122 across the metal components 160 is dictated by the controller 110 in respect of welding speed, positioning, orientation etc.

The welding apparatus 100 further includes a first pyrometer 130 and a second pyrometer 132 disposed on the welding unit 120. The first pyrometer 130 is positioned at a predetermined distance D1 from a tip portion 123 of the torch head 122. Similarly, the second pyrometer 132 is positioned at a predetermined distance D2 from the tip portion 123 of the torch head 122. The first pyrometer 130 and the second pyrometer 132 are in communication with the controller 110. The first pyrometer 130 and the second pyrometer 132 may be statically disposed about the torch head 122 using support structures 124. In one embodiment, the first pyrometer 130 and the second pyrometer 132 may be dynamically disposed about the torch head 122 using a mechanical gear like arrangement controlled by a servo motor. The servo motor may also be in communication with the controller 110.

The first pyrometer 130 and the second pyrometer 132 may be distanced from the torch head 122 either manually or automatically. The spacing and positioning between the first and second pyrometers 130, 132 may be based on a size of a molten pool created during the welding operation while deposition of a weld bead on the metal components 160. The positioning of the first and second pyrometers 130, 132, in terms of distance and orientation or angular positioning may be adjusted based on the geometry of the surface of the metal components 160, in order to protect the first and second pyrometers 130, 132 from excessive heat, radiation, reflection of scattered light etc. during the welding operation.

The first pyrometer 130 and the second pyrometer 132 are embodied as infrared pyrometry camera or any other thermal sensing device known in the art directed at the metal components 160 to detect infrared electromagnetic radiation generated as the metal components 160 is heated by the torch head 122. In an example, the first pyrometer 130 and the second pyrometer 132 may be ratio, or dual colored, or two colored pyrometers configured to monitor intensity of radiation emitted at individual wavelengths. The first pyrometer 130 and the second pyrometer 132 enables non-contact temperature measurements on the external weld surface. Although not specifically shown, the first pyrometer 130 and the second pyrometer 132 may include a scanning and detecting device sensitive to predefined wavelengths appropriate for temperatures achieved in metal welding.

FIG. 2 illustrates a first weld pass of the welding operation performed by the welding apparatus 100, i.e. deposition of a welding material on the metal components 160 during the welding operation. The welding apparatus 100 is used for forming a first weld bead (WB1) of the welding material for joining the metal components 160. The welding material may include metal electrodes, wireline depositions, plastics, alloys, powder metals or the like materials and may depend on the type of welding operation performed. Further, characteristics related to feeding of the welding material, for example, supply speed; positioning etc. may also be governed by the controller 110. The welding material is fed through the torch head 122 during the welding operation. Alternatively, the welding material may be supplied during the welding operation via an external mechanism (not shown) separate from the welding apparatus. As explained earlier, the torch head 122, the first pyrometer 130, and the second pyrometer 132 are positioned with respect to the metal components 160 to achieve an optimum welding operation. In an embodiment, joining of the metal components 160 may require consecutive weld passes.

During the first weld pass, the controller 110 of the welding apparatus 100 is configured to modulate a three-dimensional heat input distribution across a surface of the metal components 160 over time to create a time dependent temperature field distribution throughout a weld region (WR) on the metal component 160 across which the welding operation is to be or has been performed.

The desired temperature field distribution may be selected based on the required weld bead (WB) geometry, material structure and properties, and the thermal stress/strain specifications. The desired field distribution can be designated through an off-line numerical simulation model or can be measured directly by the first pyrometer 130 and the second pyrometer 132 on a joint surface, or the desired field distribution can be evaluated by the controller 110 during a real-time welding operation

In context of the present disclosure, the desired field distribution is evaluated by the controller 110 during welding of the metal components 160 on receiving inputs from the first pyrometer 130 and the second pyrometer 132 during the first weld pass. The desired field distribution will serve as a predetermined threshold for one or more welding parameters as evaluated by the controller 110. The welding parameters may include amperage and voltage values related to torch intensity required for an optimal welding process, the welding speed of the torch head 122, the speed and quantity of the welding material supplied during the welding operation etc. The controller 110 is configured to adjust and control one or more welding parameters associated with the welding operation based on a comparison with respect to the predetermined threshold. The desired temperature field distribution in most applications will be the distribution that yields the simultaneous weld bead formation along the entire length of the weld in gradual cross-sectional increments.

As shown in FIG. 2, the first pyrometer 130 and the second pyrometer 132 are positioned at respective predetermined distances D1 and D2 from the tip portion 123 of the torch head 122. The first pyrometer 130 and the second pyrometer 132 are configured to monitor formation of the first weld bead (WB1) during the first weld pass of welding operation of the metal components 160. In operation, the first pyrometer 130 monitors temperature of at least a portion of the first weld bead (WB1) during the first weld pass. Alternatively, the first pyrometer may monitor the temperature of at least a portion of the prior weld bead during a previous weld before the welding operation. The first pyrometer 130 further generates a first temperature signal T1 indicative of temperature distribution of the first weld bead (WB1). The first temperature signal T1 is received by the controller 110 for further processing. The predetermined distance D1 of the first pyrometer 130 from the tip portion 123 is decided such that the positioning of the first pyrometer 130 is optimum for sensing the temperature of the first weld bead (WB1)

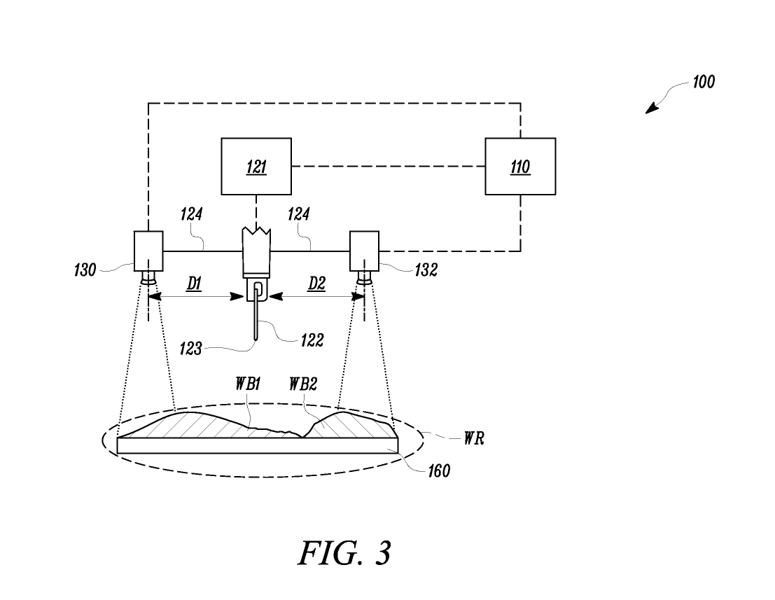

Referring to FIG. 3, the second pyrometer 132 monitors temperature of another weld bead or a second weld bead (WB2) of the welding material during a current weld that follows the previous weld of FIG. 2. Alternatively, the second pyrometer 132 monitors temperature of a portion of the first weld bead (WB1) after the welding operation of FIG. 2. The predetermined distance D2 of the second pyrometer 132 from the tip portion 123 is decided such that the positioning of the second pyrometer 132 is optimum for generating a second temperature signal T2 indicative of temperature distribution of a second weld bead (WB2) during the current weld. The second temperature T2 signal is received by the controller 110 for further processing.

As shown in FIGS. 2 and 3, the controller 110 is in communication with the power circuit 121, the first pyrometer 130, and the second pyrometer 132. The controller 110 receives the first temperature signal T1 and the second temperature signal T2 from the first pyrometer 130 and the second pyrometer 132 respectively. The controller 110 includes differential operational amplifier (OP-AMP) circuit or a proportional-integral (PI) controller. On receiving the first temperature signal T1 and the second temperature signal T2, the controller 110 generates a first reference value R1 corresponding to the first temperature signal T1 and a second reference value R2 corresponding to the second temperature signal T2.

The controller 110 further determines a difference between the first reference value R1 and the second reference value R2 represented as differential maximum value ΔR (ΔR=R2−R1) or a target temperature differential. The differential maximum value ΔR is indicative of a temperature differential corresponding to the first temperature signal T1 and the second temperature signal T2, and is further indicative of the desired time dependent temperature field distribution of the weld region (WR). The controller 110 further sets a threshold for one or more welding parameters, i.e. the amperage and voltage, the welding speed of the torch head 122 etc. corresponding to the differential maximum value ΔR. In context of welding of the metal components 160 in three-dimensional space defined by orthogonal axes X, Y, Z, the controller 110 modulates the time dependent three-dimensional heat input distribution across the weld region (WR) surface of the metal components 160 so that the desired time dependent temperature field distribution is not disturbed.

In other words, as explained earlier, the differential maximum value ΔR indicative of the desired time dependent temperature field distribution as evaluated by the controller 110 serves as the predetermined threshold for achieving an optimal welding procedure. The welding parameters, i.e. the amperage and voltage of the power circuit 121, the welding speed of the torch head 122 etc. during the welding operation are constantly modulated by the controller 110 such that the differential maximum value ΔR is not exceeded in the current weld, i.e. the threshold for one or more welding parameters as set by the controller 110 based on the previous weld is not exceeded in the current weld. For example, the controller 110 is configured to adjust the weld temperature of the current weld such that the differential maximum value ΔR is not exceeded. The one or more welding parameters (amperage and voltage) associated with the power circuit 121 further modulates power of the torch head 122 to achieve an optimal torch intensity for the welding procedure. Such a process will ensure an optimal, stable, and defect free geometry for the weld beads deposited over the metal components 160 over multiple welds.

Although the controller 110 is illustrated in the context of discrete blocks within an overall structure, its most likely implementation is as a software algorithm executed by a computer. Ideally, the controller 110 software would be interfaced directly to a computer-aided design (CAD) package used for the welded parts by sharing the same geometric modelling description of objects and motions and thus, serve as a thermal computer-aided manufacturing (CAM) postprocessor for scan welding. The combination of product and process design procedures in an integrated environment will contribute to the optimization of the welding performance in industrial applications.

The controller 110 modulates the power to the torch head 122 according to the deviation from the differential maximum value ΔR. The controller 110 evaluates the differential maximum value ΔR according to the thermal control or performance specifications and dynamic welding process parameters, such as, the arc efficiency. These process parameters are variable in space and time during the operation because of heat transfer nonlinearities, thermal drift of the arc and material properties, and disturbances of the torch characteristics and the weld geometry configuration. Thus, to ensure the maximal closed-loop performance, these parameters must be a function of real-time temperature measurements.

It may be contemplated that the welding apparatus 100 may include multiple thermal sensing devices (pyrometers) disposed on the torch head 122. In an embodiment, the multiple thermal sensing devices may be in communication with a plurality of controllers 110. Alternatively, a separate controller 110 may be provided for each thermal sensing device. Further, the orientation and dimensions of the thermal sensing devices are not limited to that described herein.

### INDUSTRIAL APPLICABILITY

The present disclosure relates to the welding apparatus 100 configured to conduct a welding operation on the metal components 160. The welding apparatus 100 includes the controller 110 in communication with the power circuit 121, the torch head 122, the first pyrometer 130, and the second pyrometer 132. As explained earlier, the first pyrometer 130 and the second pyrometer 132 are disposed around the torch head 122 and are configured to monitor a plurality of weld regions on the component. The first pyrometer 130 and the second pyrometer 132 are further configured to generate signals indicative of temperature distribution around the plurality of weld regions. The signals are received by the controller 110, and the controller 110 evaluates a temperature differential from the signals. The controller 110 further modulates welding parameters of the power circuit 121, such that the temperature differential with respect to the previous weld is not exceeded during the current weld and thereby preventing overheating of the weld region (WR). Such a process ensures an optimal welding process where improved weld bead geometry with lesser or no defects is attained. Further, as the temperature distribution of the weld region (WR) between consecutive welds is controlled within limits, welding material build up collapse is also countered effectively.

The components described with respect to the welding apparatus 100 are highly flexible and are easily configurable with conventional joining processes known in the modern manufacturing technology. These conventional processes employed a single, localized, sequentially moving torch or weld head which leads to steep temperature distribution on a weld region causing structural defects and residual stresses in the component. The welding apparatus 100 overcomes all such defects in a flexible and cost effective manner.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A welding apparatus for applying consecutive welding beads during a welding operation, the welding apparatus comprising:
a welding unit including a torch head and a power circuit associated with the welding unit;
a first pyrometer being positioned at a first pre-determined distance from a tip portion of the torch head, the first pyrometer configured to generate a first temperature signal indicative of a temperature of a portion of a previous weld;
a second pyrometer being positioned at a second pre-determined distance from the tip portion of the torch head, the second pyrometer configured to generate a second temperature signal indicative of a temperature of a portion of a current weld; and
a controller in communication with the power circuit, the first pyrometer, and the second pyrometer, the controller configured to:
receive the first temperature signal and the second temperature signal;
determine a difference between the first and second temperature signals;
set a predetermined threshold based, at least in part, on the determined difference; and
adjust a welding parameter of the power circuit, wherein the adjusted welding parameter is lesser than the predetermined threshold.
